(19) United States
(12) Patent Application Publication
(10) Pub. No.: US 2015/0346824 A1
(43) Pub. Date: Dec. 3, 2015

(54) Electronic Devices with Low Power Motion Sensing and Gesture Recognition Circuitry

(71) Applicant: Apple Inc., Cupertino, CA (US)

(72) Inventors: Kuan-Lin Chen, Sunnyvale, CA (US); William S. Lee, Fremont, CA (US)

(73) Assignee: Apple Inc., Cupertino, CA (US)

(21) Appl. No.: 14/288,113

(22) Filed: May 27, 2014

(51) Int. Cl. G06F 3/01; H04N 21/422; H04N 5/44

(52) U.S. Cl. CPC G06F 3/017; H04N 5/4403; H04N 21/42204; H04N 21/4222; H04N 2005/4425; H04N 2005/4432

(57) ABSTRACT

A user may provide input to a handheld electronic device by making gestures with the handheld electronic device. The input gestures may be used to generate remote control signals for external equipment. The electronic device may include circuitry for detecting a user's movement of the handheld electronic device. The circuitry may include an accelerometer operable in normal and low power modes and a processor operable in sleep and wake modes. Motion data gathered in low power mode may be stored in a dedicated low power mode data storage structure. Motion analysis circuitry may detect a user's movement of the electronic device based on a standard deviation of the motion data. Upon detecting a user's movement of the handheld electronic device, the processor may be woken up to analyze the motion data stored in the low power mode data storage structure and to confirm the user's movement of the electronic device.

### BACKGROUND

This relates generally to electronic devices and, more particularly, to handheld electronic devices that have remote control functionality and gesture recognition capabilities.

Remote controls are commonly used for controlling televisions, set-top boxes, stereo receivers, and other consumer electronic devices. Remote controls have also been used to control appliances such as lights, window shades, and fireplaces.

Conventional remote controls typically have a large number of buttons. This may lead to frustration as a user is forced to switch focus between pressing the correct button on the remote control and viewing information on a television or other device that is being controlled by the remote control.

To provide the user with an input mechanism other than physical buttons, some remote controls include a motion sensor for detecting a user's movement of the remote control. The user's movement of the remote control may be used to generate remote control signals to remotely control a media device or system.

To conserve battery power, remote controls with motion sensing capabilities often support low power operating modes. For example, when the remote control is not being used, the motion sensor in the remote control may be placed in a low power mode during which sensor measurements are gathered at a reduced rate.

Motion sensors that can operate in low power mode and normal mode typically store both low power mode data and normal mode data in a single first-in-first-out (FIFO) data storage location. When the sensor is operating back and forth between low power mode and normal mode, the sensor data in the FIFO is indistinguishable with respect to the operating mode. Without being able to distinguish low power mode data from normal mode data, the sensor must gather a new set of measurements in normal mode when motion is detected rather than relying on the historic motion data stored in the FIFO. This reduces power consumption efficiency and can in turn reduce the battery life of the remote control. Moreover, the inability to rely on historic motion data can degrade performance as the motion event that triggered the sensor to switch into normal mode may not be repeated.

It would therefore be desirable to be able to provide improved ways for electronic devices such as electronic devices with remote control functionality to detect a user's movement of the electronic device.

### SUMMARY

A handheld electronic device may have the ability to perform gesture recognition operations. The handheld electronic device may have remote control functionality. If desired, the handheld electronic device may also have cellular telephone, music player, or handheld computer functionality.

A user may provide input to the handheld electronic device by making a gesture with the handheld electronic device. The input gesture may be used to generate remote control signals for external equipment.

The handheld electronic device may include circuitry for detecting a user's movement of the handheld electronic device. The circuitry may include a motion sensor operable in a normal mode and a low power mode and a processor operable in sleep and wake modes.

The circuitry may include first and second data storage structures. The first data storage structure may be used to store motion data gathered by the motion sensor when the motion sensor is operated in normal mode, whereas the second data storage structure may be used to store motion data that is gathered by the motion sensor when the motion sensor is operated in low power mode.

When the electronic device is not in use (e.g., when the electronic device is at rest on a surface), the motion sensor may be operated in a low power mode while the processor remains in a sleep state. The low power mode motion data may be stored in the dedicated low power mode data storage structure.

Motion analysis circuitry may be used to monitor for a user's movement of the electronic device while the processor is asleep. For example, the motion analysis circuitry may analyze the low power mode motion data in the low power mode data storage structure to detect when a user lifts up the electronic device to begin supplying input gestures to the electronic device. The motion analysis circuitry may detect a user's movement of the electronic device based on a standard deviation associated with the motion data.

When the motion analysis circuitry detects a user's movement of the handheld electronic device, the processor may be woken up to analyze the low power mode motion data stored in the low power mode data storage structure and to confirm the user's movement of the electronic device. Because the low power mode data is distinguishable from the normal mode data, the processor can confirm the user's movement of the electronic device using the historical data rather than waiting for a new cycle of measurements to be gathered.

If desired, additional motion data may be gathered while operating the motion sensor in normal mode before waking up the processor to confirm a user's movement of the electronic device. In this scenario, the processor may rely on both the historical low power data as well as normal mode data to confirm the user's movement of the electronic device.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device of the type that may be provided with motion sensing and gesture recognition circuitry in accordance with an embodiment of the present invention.

FIG. 2 is a schematic view of an illustrative system including an electronic device of the type that may be provided with motion sensing and gesture recognition circuitry in accordance with an embodiment of the present invention.

FIG. 3 is a schematic view of illustrative motion sensing and gesture recognition circuitry in accordance with an embodiment of the present invention.

FIG. 4 is a graph showing an illustrative acceleration profile of a lift event in accordance with an embodiment of the present invention.

FIG. 5 is a graph showing an illustrative acceleration profile of a bump event in accordance with an embodiment of the present invention.

FIG. 6 is a flow chart of illustrative steps involved in monitoring for a lift event using motion analysis circuitry in accordance with an embodiment of the present invention.

FIG. 7 is a timing diagram showing a first scheme of operating modes of an accelerometer and a processor before and after a false detection event in accordance with an embodiment of the present invention.

FIG. 8 is a timing diagram showing a second scheme of operating modes of an accelerometer and a processor before and after a false detection event in accordance with an embodiment of the present invention.

FIG. 9 is a timing diagram showing a conventional scheme of operating modes of an accelerometer and a processor before and after a false detection event.

FIG. 10 is a flow chart of illustrative steps involved in performing motion detection and gesture recognition functions in an electronic device in accordance with an embodiment of the present invention.

FIG. 11 is a flow chart of illustrative steps involved in performing motion detection and gesture recognition functions in an electronic device in accordance with an embodiment of the present invention.

### DETAILED DESCRIPTION

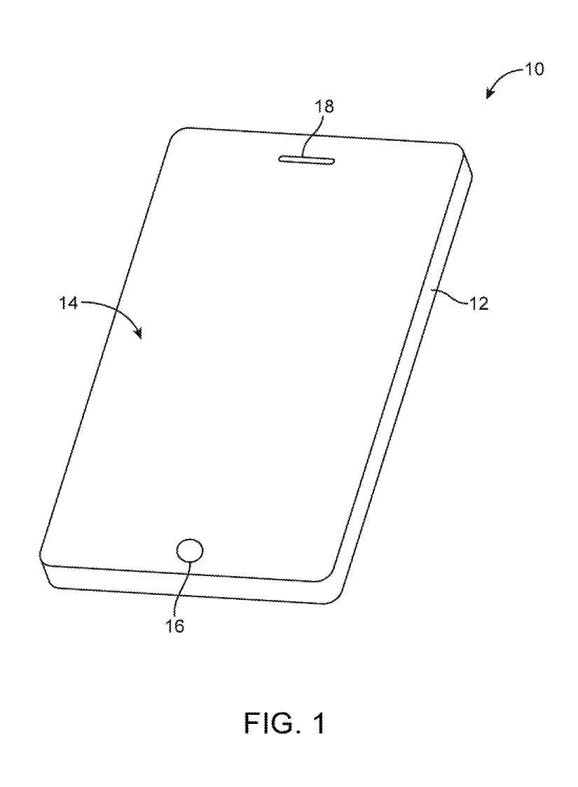

An illustrative electronic device that may be provided with motion sensing and gesture recognition circuitry is shown in FIG. 1. Electronic device 10 of FIG. 1 may be a handheld electronic device or other electronic device. For example, electronic device 10 may be a cellular telephone, media player, or other handheld portable device, a somewhat smaller portable device such as a wrist-watch device, pendant device, or other wearable or miniature device, gaming equipment, a tablet computer, a notebook computer, a desktop computer, a television, a computer monitor, a computer integrated into a computer display, or other electronic equipment. Electronic device 10 may, for example, be a remote control. Illustrative configurations for device 10 in which device 10 includes components that allow device 10 to serve as a remote control for controlling external equipment are sometimes described herein as an example. This is, however, merely illustrative. Device 10 may be any suitable electronic equipment.

In the example of FIG. 1, device 10 includes a display such as display 14. Display 14 has been mounted in a housing such as housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.).

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

Display 14 may include an array of display pixels formed from liquid crystal display (LCD) components, an array of electrophoretic display pixels, an array of plasma display pixels, an array of organic light-emitting diode display pixels, an array of electrowetting display pixels, or display pixels based on other display technologies. The brightness of display 14 may be adjustable. For example, display 14 may include a backlight unit formed from a light source such as a lamp or light-emitting diodes that can be used to increase or decrease display backlight levels and thereby adjust display brightness. Display 14 may also include organic light-emitting diode pixels or other pixels with adjustable intensities. In this type of display, display brightness can be adjusted by adjusting the intensities of drive signals used to control individual display pixels.

Display 14 may be protected using a display cover layer such as a layer of transparent glass or clear plastic. Openings may be formed in the display cover layer. For example, an opening may be formed in the display cover layer to accommodate a button such as button 16. An opening may also be formed in the display cover layer to accommodate ports such as speaker port 18.

Device 10 may include any suitable number of buttons such as button 16 (e.g., a single button 16, more than one button 16, two or more buttons 16, five or more buttons 16, six or more buttons 16, etc.). Buttons 16 may be formed from dome switches or other switches mounted in housing 12.

If desired, device 10 may include buttons that are organized to form a directional pad (D-pad) or other control pad, buttons such as up and down buttons, buttons that are arranged to allow control of functions such as media volume, channel selection, page up and down, menu back/forward, playback reverse, pause, stop, and forward, fast forwards and fast reverse, time period skip, cancel, enter, etc., buttons with number keys and/or letter keys, buttons with dedicated functions for a set-top box, television, or other equipment, buttons such as a power button for turning off and turning on remote equipment, or buttons having other suitable functions. The single-button arrangement of FIG. 1 is merely illustrative.

In the center of display 14, display 14 may contain an array of active display pixels. This region is sometimes referred to as the active area of the display. A rectangular ring-shaped region surrounding the periphery of the active display region may not contain any active display pixels and may therefore sometimes be referred to as the inactive area of the display. The display cover layer or other display layers in display 14 may be provided with an opaque masking layer in the inactive region to hide internal components from view by a user.

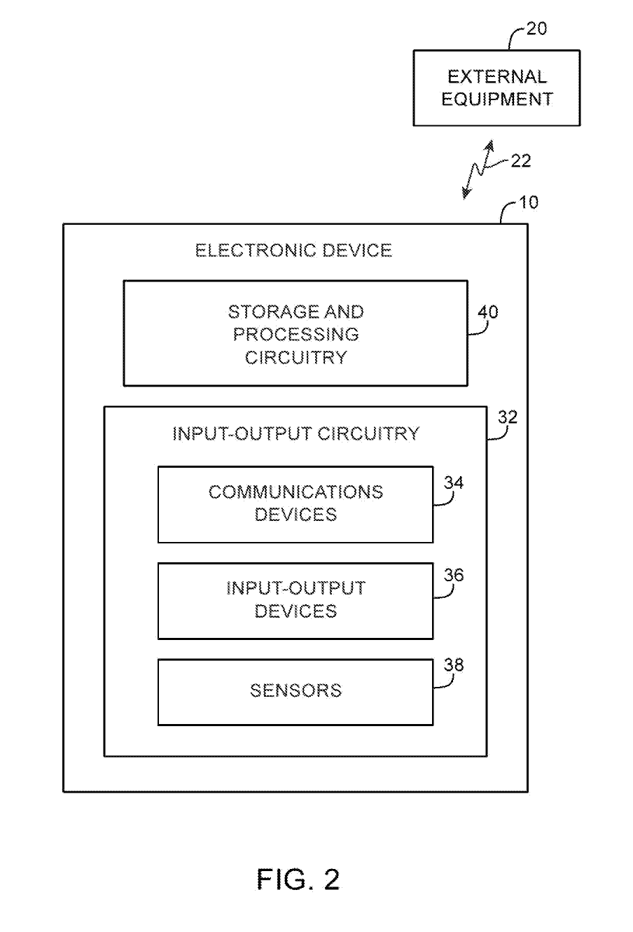

A schematic diagram of device 10 is shown in FIG. 2. As shown in FIG. 2, electronic device 10 may include control circuitry such as storage and processing circuitry 40. Storage and processing circuitry 40 may include one or more different types of storage such as hard disk drive storage, nonvolatile memory (e.g., flash memory or other electrically-programmable-read-only memory), volatile memory (e.g., static or dynamic random-access-memory), etc. Processing circuitry in storage and processing circuitry 40 may be used in controlling the operation of device 10. The processing circuitry may be based on one or more microprocessors, microcontrollers, digital signal processors, baseband processor integrated circuits, application specific integrated circuits, etc.

With one suitable arrangement, storage and processing circuitry 40 may be used to run software on device 10 such as internet browsing applications, email applications, media playback applications, operating system functions, software for capturing and processing images, software implementing functions associated with gathering and processing sensor data, software that makes adjustments to display brightness and touch sensor functionality, etc.

To support interactions with external equipment, storage and processing circuitry 40 may be used in implementing communications protocols. Communications protocols that may be implemented using storage and processing circuitry 40 include internet protocols, wireless local area network protocols (e.g., IEEE 802.11 protocols—sometimes referred to as WiFi®), protocols for other short-range wireless communications links such as the Bluetooth® protocol, etc.

Input-output circuitry 32 may be used to allow input to be supplied to device 10 from a user or external devices and to allow output to be provided from device 10 to the user or external devices.

Input-output circuitry 32 may include wired and wireless communications circuitry 34. Communications circuitry 34 may include radio-frequency (RF) transceiver circuitry formed from one or more integrated circuits, power amplifier circuitry, low-noise input amplifiers, passive RF components, one or more antennas, and other circuitry for handling RF wireless signals. Wireless signals can also be sent using light (e.g., using infrared communications).

Communications devices 34 may be used to wirelessly communicate with external equipment such as external equipment 20 over a communications path such as communications path 22. External equipment 20 may be a computer, a television, a set-top box, a media player, a display, a wearable device, a cellular telephone, or other electronic equipment.

Communications path 22 may be used for one-way or two-way transmissions between device 10 and external equipment 20. For example, device 10 may transmit remote control signals to external equipment 20 to control the operation of external equipment 20. If desired, external equipment 20 may transmit data signals to device 10.

Input-output circuitry 32 may include input-output devices 36 such as button 16 of FIG. 1, joysticks, click wheels, scrolling wheels, a touch screen such as display 14 of FIG. 1, other touch sensors such as track pads or touch-sensor-based buttons, vibrators, audio components such as microphones and speakers, image capture devices such as a camera module having an image sensor and a corresponding lens system, keyboards, status-indicator lights, tone generators, key pads, and other equipment for gathering input from a user or other external source and/or generating output for a user or for external equipment.

Sensor circuitry such as sensors 38 of FIG. 2 may include an ambient light sensor for gathering information on ambient light levels, proximity sensor components (e.g., light-based proximity sensors and/or proximity sensors based on other structures), accelerometers, gyroscopes, magnetic sensors, and other sensor structures. Sensors 38 of FIG. 2 may, for example, include one or more microelectromechanical systems (MEMS) sensors (e.g., accelerometers, gyroscopes, microphones, force sensors, pressure sensors, capacitive sensors, or any other suitable type of sensor formed using a microelectromechanical systems device). If desired, other components in device 10 may be formed using microelectromechanical systems technology.

Input-output circuitry 32 may be used to implement remote control functionality in device 10. For example, device 10 may include motion sensing circuitry and gesture recognition circuitry for detecting gesture-based remote control commands that allow device 10 to control external equipment 20 without requiring the use of dedicated remote-control buttons. The input gestures may be supplied to device 10 by a user. In response, device 10 may generate commands for external equipment 20 that remotely control external equipment 20 over path 22 (e.g., a wireless path such as an IR or RF path).

The input gestures may be supplied to device 10 using any suitable input-output device. In one illustrative arrangement, which is sometimes described herein as an example, input gestures may be supplied to device 10 by a user's movement of device 10. The input gestures may be used to generate corresponding remote control signals to supply to external equipment 20.

For example, a user may control the position of a cursor on a display in external equipment 20 by moving electronic device 10. As another example, a user may scroll through a list of menu items on a display in external equipment 20 by waving device 10 in a particular manner. In general, any suitable remote control command may be generated based on a user's movement of device 10 (e.g., commands for controlling functions such as media volume, channel selection, page up and down, menu back/forward, playback reverse, pause, stop, and forward, fast forwards and fast reverse, time period skip, cancel, enter, etc.).

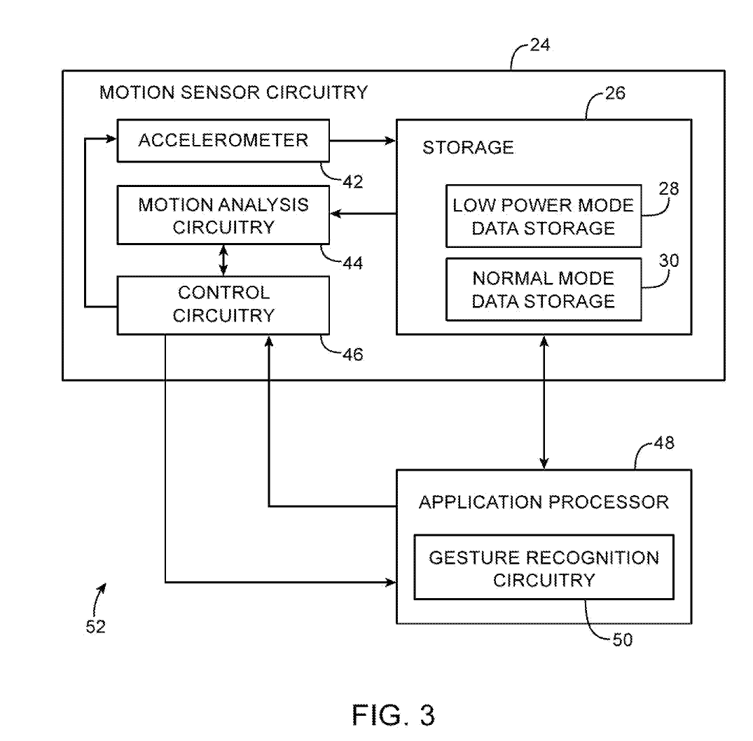

A schematic diagram showing illustrative components that may be used in device 10 to detect a user's gestures is shown in FIG. 3. As shown in FIG. 3, motion sensing and gesture recognition circuitry 52 may include motion sensor circuitry 24 and processing circuitry 48. Processor 48 may be an application processor (AP) system on chip including one or more central processing units, graphics processing units, memory, memory controllers, analog circuitry, and/or other circuitry.

Motion sensor circuitry 24 may be a system on chip integrated circuit including a motion sensor such as motion sensor 42 for detecting movement of device 10. Motion sensor 42 may, for example, be an accelerometer such as a three-axis accelerometer. This is, however, merely illustrative. If desired, motion sensor 42 may include one or more accelerometers, one or more gyroscopes, one or more compasses, one or more pressure sensors, other motion detection components, etc. Arrangements in which motion sensor 42 is an accelerometer are sometimes described herein as an example. If desired, motion sensor 42 may be formed from microelectromechanical systems structures.

Motion sensor circuitry 24 may include storage such as storage 26 for storing motion data gathered by accelerometer 42. Storage 26 may, for example, include low power mode data storage 28 and normal mode data storage 30. Low power mode data storage 28 may be used to store accelerometer data that is gathered by accelerometer 42 when accelerometer 42 is operated in low power mode. Normal mode data storage 30 may be used to store accelerometer data that is gathered by accelerometer 42 when accelerometer 42 is operated in normal mode. Storage 28 and 30 may be implemented using first-in-first-out (FIFO) storage structures. This is, however, merely illustrative. If desired, other types of memory may be used to store accelerometer data (e.g., hard disk drive storage, nonvolatile memory, volatile memory, etc.).

Motion sensing and gesture recognition circuitry 52 may include circuitry for analyzing sensor data such as motion analysis circuitry 44 and gesture recognition circuitry 50. Motion analysis circuitry 44 may apply an algorithm for detecting when device 10 transitions from a rest state in which device 10 is not being used to an in-use state in which a user picks up device 10 and begins to supply gesture-based commands to external equipment by moving device 10 in a particular manner. For example, motion analysis circuitry 44 may be configured to detect a “lift event” in which a user lifts up device 10 from a surface.

Gesture recognition circuitry 50 in processor 48 may analyze accelerometer data using a more complex algorithm than that used by motion analysis circuitry 44. For example, gesture recognition circuitry 50 may employ a gesture recognition algorithm to detect a user's movement of device 10 after motion analysis circuitry 44 detects a lift event. If desired, gesture recognition circuitry 50 may also be used to detect lift events. For example, gesture recognition circuitry 50 may be used to confirm a lift event initially detected by motion analysis circuitry 44. Upon confirming the lift event, additional accelerometer data may be read from storage 26 to processor 48 for gesture analysis using gesture recognition circuitry 50.

Motion sensor circuitry 24 may include control circuitry 46 for controlling operation of motion sensor circuitry 24 and for communicating with processor 48. For example, control circuitry 46 may be configured to control the mode in which accelerometer 42 operates (e.g., low power mode or normal mode), issue interrupt signals to processor 48 to wake up processor 48 from a sleep mode, to control the operation of motion analysis circuitry 44, and to send signals to and receive signals from processor 48.

Motion sensing and gesture recognition circuitry 52 may be operable in a low power mode. For example, when device 10 is at rest and is not being operated by a user, processor 48 may operate in a sleep state while motion sensor circuitry 44 monitors for a lift event in which a user picks up device 10. While monitoring for a lift event, accelerometer 42 may operate in a low power mode. In low power mode, accelerometer data may be gathered at a reduced rate compared to normal mode. The low power mode accelerometer data may be stored in low power mode data storage 28 and may be analyzed by motion analysis circuitry 44 to determine when a lift event occurs.

When a lift event is detected by motion analysis circuitry 44, control circuitry 46 may awaken processor 48 by issuing an interrupt signal to processor 48. Processor 48 may use gesture recognition circuitry 50 to confirm whether a lift event actually occurred. Upon confirming the lift event, control circuitry 46 may switch accelerometer 42 into normal mode to increase the rate at which accelerometer data is gathered, and the accelerometer data may be stored in normal mode data storage 30. Gesture recognition circuitry 50 may analyze the normal mode accelerometer data to determine which gestures a user makes with device 10. The gestures detected by gesture recognition circuitry 50 may be used to generate corresponding remote control signals for external equipment 20 (FIG. 2). If desired, control circuitry 46 may switch motion analysis circuitry 44 into a sleep state, off state, or low-power mode when processor 48 is awake and gesture recognition circuitry 50 is being used to analyze accelerometer data.

In some scenarios, low power mode accelerometer data may be used to determine when processor 48 should be switched from wake mode to sleep mode. For example, accelerometer 42 may operate in low power mode while electronic device 10 is in use and processor 48 is awake. Motion analysis circuitry 44 and/or gesture recognition circuitry 50 may analyze the low power mode accelerometer data in low power mode data storage 28 to monitor for movement of electronic device 10. When little or no motion is detected over a predetermined period of time, control circuitry 46 may issue instructions to switch processor 48 into sleep mode.

Because the power consumption of device 10 increases significantly when processor 48 is awake, care must be taken to avoid false detection events in motion analysis circuitry 44. For example, a user (or other object) may occasionally bump into device 10 without actually lifting device 10 up. If motion analysis circuitry 44 were to falsely identify the bump event as a lift event, processor 48 would be woken up unnecessarily, leading to reduced power consumption efficiency.

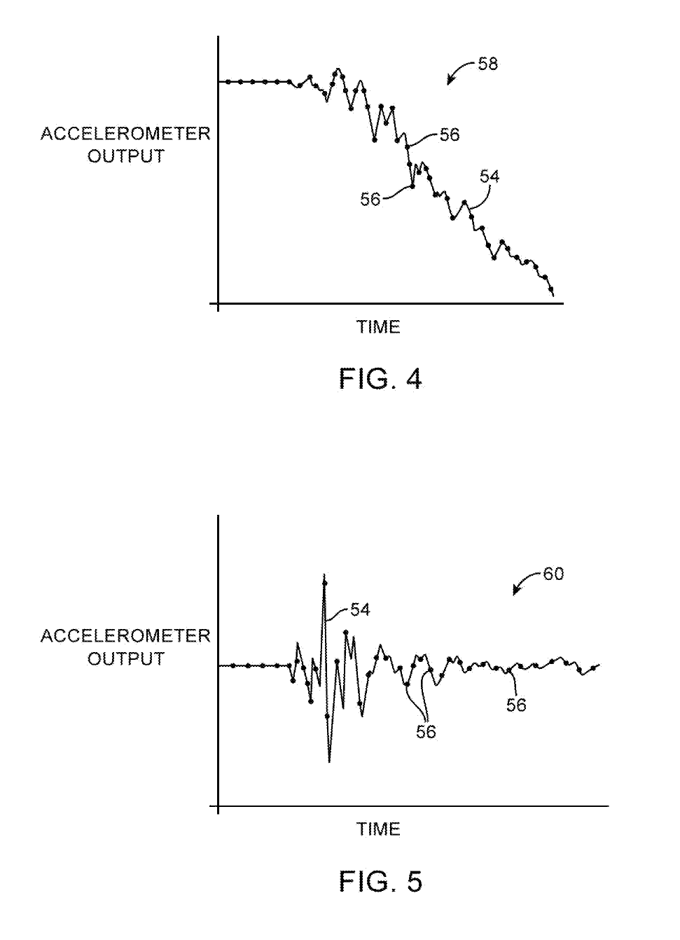

FIGS. 4 and 5 are diagrams showing illustrative acceleration data that may be gathered by accelerometer 42 of FIG. 3. Acceleration profile 58 of FIG. 4 shows accelerometer data for a lift in which device 10 is lifted from a surface. Acceleration profile 60 of FIG. 5 shows accelerometer data for a bump event in which a user or other object inadvertently bumps into device 10. Solid lines 54 indicate accelerometer data gathered in normal mode, while dots 56 indicate downsampled data gathered in low power mode. The accelerometer output may be given in m/s² or may, if desired, be given in g-force units (sometimes referred to as units of G or g).

Conventional on-chip motion detection algorithms calculate the slope between two consecutive data points (e.g., between two consecutive data points such as data points 56). For the lift event of FIG. 4, the maximum absolute slope between two consecutive points may, for example, be 7.4 G/sec. For the bump event of FIG. 5, on the other hand, the maximum absolute slope between two consecutive may be 14.7 G/sec. Thus, using the conventional slope method for motion detection, a threshold must be set below 7.4 G/sec to detect the lift event of FIG. 4, which in turn leads to falsely identifying bump events such as the bump event of FIG. 5 as lift events.

To minimize the number of false positives detected by motion analysis circuitry 44, motion analysis circuitry 44 may include standard deviation detection circuitry for calculating a root mean square value or standard deviation value of a data set and for comparing that value to a threshold. In the lift event of FIG. 4, for example, the standard deviation (root mean square) for thirty data points 56 of acceleration profile 58 may be 141 g-units (as an example). In the bump event of FIG. 5, on the other hand, the standard deviation for thirty data points 56 of acceleration profile 60 may be 46 g-units (as an example). Thus, using a standard deviation method, a threshold can be chosen to be between 46 and 141 g-units to detect true lift events such as the lift event of FIG. 4 and avoid falsely identifying bump events such as the bump event of FIG. 5 as lift events. This is, however, merely illustrative. In general, the standard deviation or root mean square threshold may be set to any suitable value.

Motion detection false positives may also be minimized by determining a peak-to-peak range value associated with the accelerometer data. For example, motion analysis circuitry 44 may include peak-to-peak detection circuitry for calculating a peak-to-peak range value of a data set and for comparing that value to a threshold. If desired, the peak-to-peak range value may be compared with the standard deviation value to determine whether or not a lift event occurred. For example, if the ratio of peak-to-peak range to standard deviation is between 1:1 and 3:1, the event may be identified as a lift event. If the ratio of peak-to-peak range to standard deviation is 5:1 or greater, the event may be identified as a bump event (as examples).

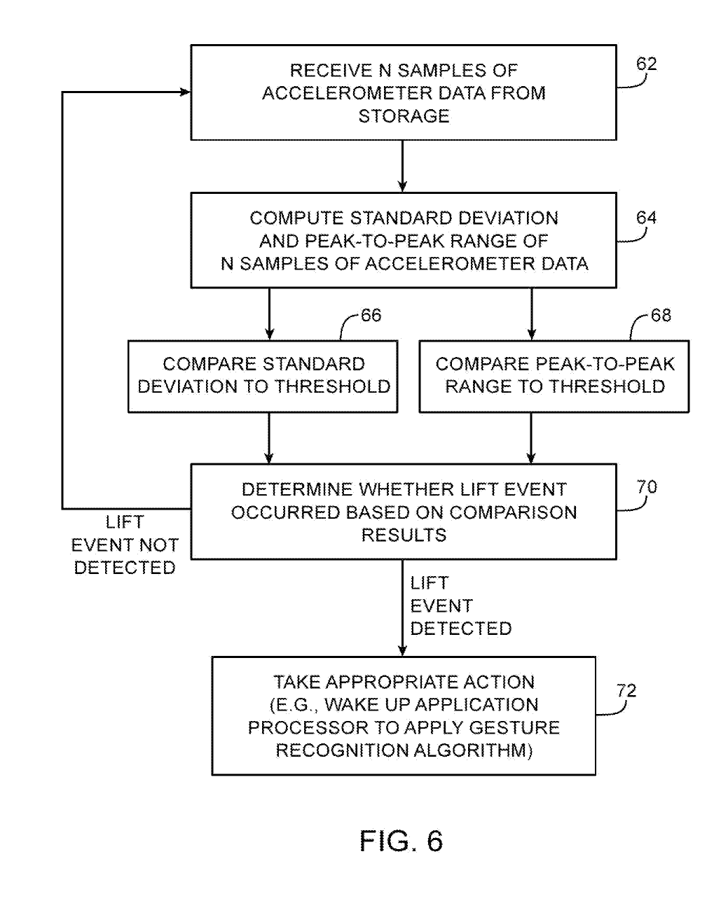

FIG. 6 is a flow chart of illustrative steps involved in monitoring for a lift event using motion analysis circuitry 44 of FIG. 3.

At step 62, motion analysis circuitry 44 may receive N samples of accelerometer data from storage 26, where N is a positive integer (e.g., N may be equal to 10, 20, 30, a value greater than 30, a value less than 30, etc.). If accelerometer 42 is operating in low power mode, motion analysis circuitry 44 may receive the accelerometer data from low power mode data storage 28. If accelerometer 42 is operating is normal mode, motion analysis circuitry 44 may receive the accelerometer data from normal mode data storage 30.

At step 64, motion analysis circuitry 44 may compute the standard deviation and peak-to-peak range values associated with the N samples of accelerometer data.

At step 66, motion analysis circuitry 44 may compare the standard deviation value with a threshold standard deviation value (e.g., using a first threshold comparator). The result of the comparison (e.g., a true value if the standard deviation exceeds the threshold or a false value if the standard deviation does not exceed the threshold) may be provided to a detection logic circuit in circuitry 44.

At step 68, motion analysis circuitry 44 may compare the peak-to-peak range value with a threshold peak-to-peak range value (e.g., using a second threshold comparator). The result of the comparison (e.g., a true value if the peak-to-peak range exceeds the threshold or a false value if the peak-to-peak range does not exceed the threshold) may be provided to the detection logic circuit in circuitry 44.

At step 70, motion analysis circuitry 44 may determine whether a lift event occurred based on the comparison results (e.g., based on the outputs of the first and second comparators). For example, motion analysis circuitry 44 may include detection logic including one or more logic gates (e.g., one or more AND logic gates, OR logic gates, NOT logic gates, NAND logic gates, NOR logic gates, EOR logic gates, ENOR logic gates, etc.) for determining whether a lift event occurred.

If it is determined that a lift event has not occurred, processing may loop back to step 62 to continue evaluating accelerometer data using motion analysis circuitry 44 (e.g., without waking up application processor 48).

If motion analysis circuitry 44 determines that a lift event occurred, processing may proceed to step 72. At step 72, control circuitry 46 may take appropriate action. For example, control circuitry 46 may issue an interrupt signal to processor 48 to wake up processor 48, and/or control circuitry 46 may switch accelerometer 42 into normal mode to begin collecting accelerometer data at an increased rate.

By relying on data parameters such as standard deviation and peak-to-peak range, the number of false detections caused by short pulses of sensor data may be minimized. This in turn helps increase power consumption efficiency by avoiding unnecessarily waking up processor 48.

While avoiding false detection events altogether is ideal, it may be desirable to implement methods to minimize power consumption in the event of a false detection. In the system of FIG. 3, the largest contribution to power consumption of the system is made by processor 48 when it is awake. Thus, power consumption efficiency may be maximized by minimizing the length of time for which processor 48 is awake after a false detection event.

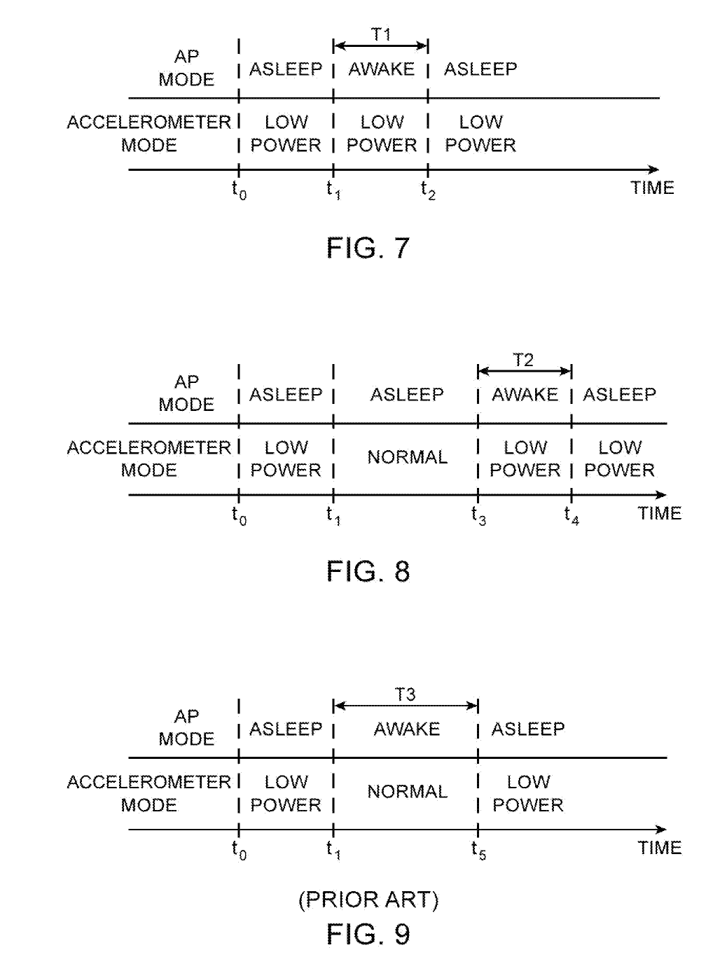

FIGS. 7 and 8 are timing diagrams illustrating the operating modes of accelerometer 42 and processor 48 of FIG. 3 in the event of a false detection (e.g., a movement of device 10 that is falsely identified as a lift event).

As shown in FIG. 7, processor 48 (AP) may operate in sleep mode and accelerometer 42 may operate in low power mode from time t0 to time t1. During this time, device 10 may be at rest on a surface (e.g., may not be in-use by a user). During this time, accelerometer 42 gathers data at a downsampled rate and stores the data in low power mode data storage 28. Motion analysis circuitry 44 monitors for a lift event by analyzing the accelerometer data in low power mode data storage 28 (e.g., using the method of FIG. 6).

At time t1, motion analysis circuitry 44 may detect movement of device 10 that is falsely identified as a lift event. In response, control circuitry 46 may wake up processor 48 by issuing an interrupt signal to processor 48. Processor 48 may retrieve the historical data from low power mode data storage 28 (i.e., the data that triggered the false detection) and may apply a more complex algorithm using gesture recognition circuitry 50 to confirm whether or not the movement was a lift event. At time t2, processor 48 determines that the movement was not a lift event and returns to sleep mode. As shown in FIG. 7, accelerometer 42 may remain in low power mode throughout the process (e.g., may remain asleep from time t0 to t2 and later). Using the method of FIG. 7, processor 48 is awake for a total time of T1 as a result of the false detection event.

FIG. 8 illustrates another suitable method for verifying a lift event that is initially detected by motion analysis circuitry 44. As shown in FIG. 8, processor 48 may operate in sleep mode and accelerometer 42 may operate in low power mode from time t0 to time t1. During this time, device 10 may be at rest on a surface (e.g., may not be in-use by a user). During this time, accelerometer 42 gathers data at a downsampled rate and stores the data in low power mode data storage 28. Motion analysis circuitry 44 monitors for a lift event by analyzing the accelerometer data in low power mode data storage 28 (e.g., using the method of FIG. 6).

At time t1, motion analysis circuitry 44 may detect movement of device 10 that is falsely identified as a lift event. In response, control circuitry 46 may switch accelerometer 42 into normal mode to begin collecting data at an increased rate. From time t1 to time t3, accelerometer 42 may collect M samples of normal mode data. The normal mode data gathered during time t1 to time t3 may be stored in normal mode data storage 30. If desired, the number of normal mode samples gathered during this time may be based on a storage limit or watermark level associated with FIFO storage 30.

At time t3, control circuitry 46 may switch accelerometer back into normal mode and may wake up processor 48 by issuing an interrupt signal. Processor 48 may read both the historical low power data from low power mode data storage 28 (e.g., the data that triggered the false detection) as well as the M samples of normal mode data from normal mode data storage 30. Processor 48 may apply a more complex algorithm using gesture recognition circuitry 50 to confirm whether or not the movement was a lift event. At time t4, processor 48 determines that the movement was not a lift event and returns to sleep mode. Using the method of FIG. 8, processor 48 is awake for a total time of T2 as a result of the false detection event. T1 and T2 may be equal or nearly equal lengths of time.

In conventional systems, both low power mode accelerometer data and normal mode accelerometer data are stored in a single FIFO. When the sensor is operating back and forth between low power mode and normal mode, the sensor data in the FIFO is indistinguishable with respect to the operating mode. Without being able to distinguish low power mode data from normal mode data, the sensor must gather a new set of measurements when motion is detected rather than relying on the historic motion data stored in the FIFO. This in turn leads to wasted power in the event of a false detection.

FIG. 9 is a timing diagram showing the operating modes of an accelerometer and processer in a conventional system that does not include a dedicated storage location for low power mode data.

From time t0 to time t1, the processor may operate in sleep mode while the accelerometer operates in low power mode. During this time, the device may be at rest on a surface. The downsampled accelerometer data is stored in a normal mode FIFO, along with any historical normal mode data that has been previously stored the normal mode FIFO.

At time t1, a movement of the device is falsely identified as a lift event. In response, the processor is woken up and the accelerometer is switched into normal mode. Because the historical data stored in the FIFO (i.e., the data that triggered the false detection) is indistinguishable with respect to the operating mode, the system must wait for the accelerometer to collect a number of samples of accelerometer data while in normal mode. After collecting the appropriate number of samples, the processor analyzes the newly collected data to confirm whether or not the device was actually picked up by a user. At time t5, the processor determines that the device was not picked up by a user, the processor returns to sleep mode, and the accelerometer returns to low power mode. In the conventional method of FIG. 9, the processor is awake for a total time of T3 as a result of the false detection event. T3 is larger than both T1 and T2 because the processor is awake for the time that it takes the accelerometer to collect new data and for the time that it takes to analyze the new data to confirm whether or not the device was picked up by a user.

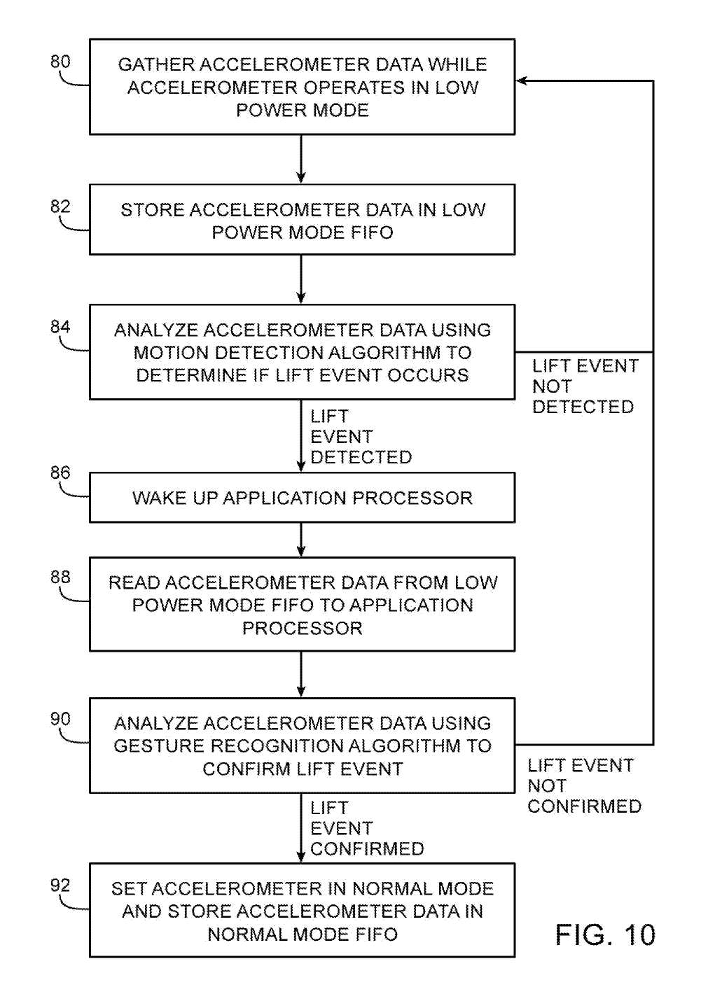

FIG. 10 is a flow chart of illustrative steps involved in performing motion detection and gesture recognition functions in an electronic device using a system of the type shown in FIG. 3.

At step 80, accelerometer 42 may gather accelerometer data while operating in low power mode. This may include, for example, measuring the acceleration of the electronic device at a downsampled rate.

At step 82, the accelerometer data gathered during step 80 may be stored in low power mode data storage 28.

At step 84, motion analysis circuitry 44 may monitor for a lift event by analyzing the accelerometer data in low power mode data storage 28. If desired, motion analysis circuitry 44 may use the method of FIG. 6 to determine whether or not a lift event occurs. This may include, for example, computing the standard deviation and/or the peak-to-peak range of N data samples stored in low power mode data storage 28.

If motion analysis circuitry 44 determines that a lift event has not occurred, processing may loop back to step 80. If motion analysis circuitry 44 determines that a lift even has occurred, processing may proceed to step 86.

At step 86, control circuitry 46 may issue an interrupt signal to wake up processor 48.

At step 88, processor 48 may read the historical data from low power mode storage 28 (i.e., the historical data that triggered the detection of the lift event). If desired, additional data may be provided to processor 48 (e.g., standard deviation information, peak-to-peak range information, etc.).

At step 90, processor 48 may apply a gesture recognition algorithm (e.g., a more complex algorithm than that used by motion analysis circuitry 44) using gesture recognition circuitry 50 to confirm whether or not the movement detected by motion analysis circuitry was actually a lift event.

If processor 48 determines that the movement was not a lift event, processing may loop back to step 80, where processor 48 returns to sleep mode and accelerometer 42 continues to gather accelerometer data in low power mode. If processor 48 confirms that the movement was a lift event, processing may proceed to step 92.

At step 92, control circuitry 46 may switch accelerometer 42 into normal mode to begin collecting accelerometer data at an increased rate. The accelerometer data may be stored in normal mode data storage 30 and may be analyzed by gesture recognition circuitry 50. For example, after picking up device 10 (and triggering the corresponding lift event), the user may begin to supply input gestures to device 10 by moving device 10 in a particular manner. Processor 48 (or other processing circuitry in device 10) may generate corresponding remote control signals based on the input gestures and the remote control signals may be transmitted to external equipment (e.g., external equipment 20 over communications path 22 of FIG. 2).

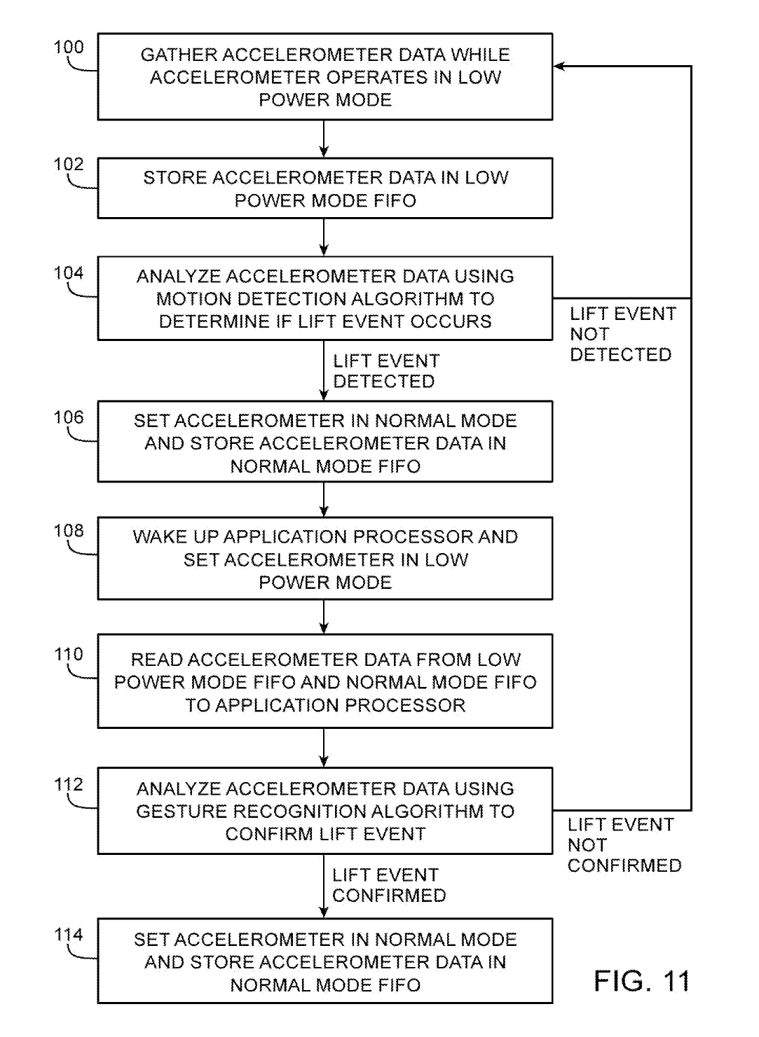

FIG. 11 is a flow chart of illustrative steps involved in performing motion detection and gesture recognition functions in an electronic device using a system of the type shown in FIG. 3.

At step 100, accelerometer 42 may gather accelerometer data while operating in low power mode. This may include, for example, measuring the acceleration of the electronic device at a downsampled rate.

At step 102, the accelerometer data gathered during step 100 may be stored in low power mode data storage 28.

At step 104, motion analysis circuitry 44 may monitor for a lift event by analyzing the accelerometer data in low power mode data storage 28. If desired, motion analysis circuitry 44 may use the method of FIG. 6 to determine whether or not a lift event occurs. This may include, for example, computing the standard deviation and/or the peak-to-peak range of N data samples stored in low power mode data storage 28.

If motion analysis circuitry 44 determines that a lift event has not occurred, processing may loop back to step 100. If motion analysis circuitry 44 determines that a lift even has occurred, processing may proceed to step 106.

At step 106, control circuitry 46 may switch accelerometer 42 into normal mode to begin collecting accelerometer data at an increased rate. The normal mode data may be stored in normal mode data storage 30. Accelerometer 42 may collect M samples of normal mode data while processor 48 remains in sleep mode.

At step 108, control circuitry 46 may switch accelerometer 42 back into low power mode and may issue an interrupt signal to wake up processor 48. Power savings may be achieved by switching accelerometer 42 back into low power mode while processor 48 analyzes the accelerometer data during step 110 to confirm the lift event. This is, however, merely illustrative. If desired, accelerometer 42 may remain in normal mode while processor 48 verifies whether or not the detected movement was a lift event.

At step 110, processor 48 may read the historical data from low power mode data storage 28 (i.e., the historical data that triggered the detection of the lift event) as well as the normal mode data from normal mode storage 30 (i.e., the M samples of data gathered during step 106). If desired, additional data may be provided to processor 48 (e.g., standard deviation information, peak-to-peak range information, etc.).

At step 112, processor 48 may apply a gesture recognition algorithm (e.g., a more complex algorithm than that used by motion analysis circuitry 44) using gesture recognition circuitry 50 to confirm whether or not the movement detected by motion analysis circuitry 44 was actually a lift event.

If processor 48 determines that the movement was not a lift event, processing may loop back to step 100, where processor 48 returns to sleep mode and accelerometer 42 continues to gather accelerometer data in low power mode. If processor 48 confirms that the movement was a lift event, processing may proceed to step 114.

At step 114, control circuitry 46 may switch accelerometer 42 into normal mode to begin collecting accelerometer data at an increased rate. The accelerometer data may be stored in normal mode data storage 30 and may be analyzed by gesture recognition circuitry 50. For example, after picking up device 10 (and triggering the corresponding lift event), the user may begin to supply input gestures to device 10 by moving device 10 in a particular manner. Processor 48 (or other processing circuitry in device 10) may generate corresponding remote control signals based on the input gestures and the remote control signals may be transmitted to external equipment (e.g., external equipment 20 over communications path 22 of FIG. 2).

The foregoing is merely illustrative of the principles of this invention and various modifications can be made by those skilled in the art without departing from the scope and spirit of the invention.

What is claimed is:

1. A handheld electronic device, comprising:
a motion sensor that gathers low power mode motion data in a low power mode and normal mode motion data in a normal mode;
first storage circuitry and second storage circuitry, wherein the normal mode motion data is stored in the first storage circuitry and wherein low power mode motion data is stored in the second storage circuitry; and
a processor that reads the low power mode motion data stored in the second storage circuitry and that detects a user's motion based on the low power mode motion data.

2. The handheld electronic device defined in claim 1 wherein the motion sensor comprises an accelerometer.

3. The handheld electronic device defined in claim 1 wherein the first storage circuitry and the second storage circuitry each comprise first-in-first-out storage circuitry.

4. The handheld electronic device defined in claim 1 wherein the motion sensor, the first storage circuitry, and the second storage circuitry form part of an integrated circuit.

5. The handheld electronic device defined in claim 4 wherein the integrated circuit comprises motion analysis circuitry and wherein the motion analysis circuitry detects the user's motion based on the low power mode motion data stored in the second data storage circuitry.

6. The handheld electronic device defined in claim 5 wherein the motion analysis circuitry includes standard deviation detection circuitry and peak-to-peak detection circuitry.

7. The handheld electronic device defined in claim 5 wherein the processor is operable in a sleep state and a wake state and wherein the control circuitry issues an interrupt signal to wake up the processor based on information from the motion analysis circuitry.

8. The handheld electronic device defined in claim 7 wherein the processor comprises gesture recognition circuitry that detects user input gestures supplied to the handheld electronic device based on the normal mode motion data gathered by the motion sensor.

9. The handheld electronic device defined in claim 8 wherein the processor generates remote control signals based on the user input gestures.

10. The handheld electronic device defined in claim 9 further comprising wireless communications circuitry with which the handheld electronic device transmits the remote control signals to external equipment.

11. A method for operating an electronic device having a motion sensor and a processor, comprising:
while operating the motion sensor in a low power mode and the processor in a sleep state, gathering low power mode motion data and storing the low power mode motion data in low power mode data storage circuitry;
with motion analysis circuitry, detecting a user's movement of the electronic device based on the low power mode motion data in the low power mode data storage circuitry; and
in response to detecting the user's movement of the electronic device, waking up the processor and, with the processor, confirming the user's movement of the electronic device based on the low power mode motion data in the low power mode data storage circuitry.

12. The method defined in claim 11 wherein detecting the user's movement of the electronic device comprises detecting the user's movement of the electronic device based on a standard deviation of the low power mode motion data.

13. The method defined in claim 11 further comprising:
in response to confirming the user's movement of the electronic device, switching the motion sensor into normal mode and gathering normal mode motion data while operating the motion sensor in normal mode; and
storing the normal mode motion data in normal mode data storage circuitry.

14. The method defined in claim 13 further comprising:
with gesture recognition circuitry in the processor, detecting input gestures supplied to the electronic device by the user based on the normal mode motion data.

15. The method defined in claim 14 further comprising:
with the processor, generating remote control signals based on the input gestures; and
with wireless communications circuitry in the electronic device, transmitting the remote control signals to external equipment.

16. A method for operating an electronic device having a motion sensor and a processor, comprising:
while operating the motion sensor in a low power mode and the processor in a sleep state, gathering low power mode motion data and storing the low power mode motion data in first data storage circuitry;
with motion analysis circuitry, detecting a user's movement of the electronic device based on the low power mode motion data in the first data storage circuitry;
in response to detecting the user's movement of the electronic device, gathering normal mode motion data while operating the motion sensor in normal mode and storing the normal mode motion data in second data storage circuitry; and
after gathering the normal mode motion data, waking up the processor and, with the processor, confirming the user's movement of the electronic device based on the low power mode motion data and the normal mode motion data.

17. The method defined in claim 16 wherein gathering the low power mode motion data comprises gathering the low power mode motion data at a first rate, wherein gathering the normal mode motion data comprises gathering the normal mode motion data at a second rate, and wherein the first rate is lower than the second rate.

18. The method defined in claim 16 wherein detecting the user's movement of the electronic device based on the low power mode motion data comprises comparing a standard deviation value associated with the low power mode motion data to a threshold.

19. The method defined in claim 18 wherein detecting the user's movement of the electronic device based on the low power mode motion data comprises determining a peak-to-peak range value associated with the low power mode motion data.

20. The method defined in claim 16 further comprising:
operating the motion sensor in low power mode while the processor is confirming the user's movement of the electronic device.

21. The method defined in claim 20 further comprising:
in response to confirming the user's movement of the electronic device, switching the motion sensor into normal mode and gathering additional motion data while operating the motion sensor in normal mode; and
storing the additional motion data in the second data storage circuitry.

22. The method defined in claim 21 further comprising:
with gesture recognition circuitry in the processor, detecting input gestures supplied to the electronic device by the user based on the additional motion data;
with the processor, generating remote control signals based on the input gestures; and
with wireless communications circuitry in the electronic device, transmitting the remote control signals to external equipment.
